(19) United States
(12) Patent Application Publication
(10) Pub. No.: US 2015/0277719 A1
(43) Pub. Date: Oct. 1, 2015

(54) SYSTEM AND METHOD FOR PROVIDING SIMPLIFIED PATH AND POINTS OF INTEREST USER INTERFACES

(71) Applicant: Hidekazu Minami, Brooklyn, NY (US)

(72) Inventor: Hidekazu Minami, Brooklyn, NY (US)

(21) Appl. No.: 14/226,091

(22) Filed: Mar. 26, 2014

(51) Int. Cl. G06F 3/0484; H04W 4/04; H04L 29/08; H04W 4/02

(52) U.S. Cl. CPC G06F 3/04847; G06F 3/04842; H04W 4/025; H04W 4/043; H04L 67/18

(57) ABSTRACT

Embodiments of the present invention are generally directed towards systems and methods for user interface generation. Specifically, embodiments of the present invention are configured to provide a system and method for providing one or more user interfaces capable of displaying path and points of interest information data in an easily understandable and consumable manner. In a preferred embodiment, the system is configured to receive location information and generate location specific information into an easily readable and accessible user interface for display on a display element, such as a screen of a smartphone or tablet PC. In this preferred embodiment, the user interface is configured to display path and points of interest on a linear format without inclusion of nonessential information or standard geographic divergences (e.g., curves, bends, elevation change).

Embodiments of the present invention are generally directed towards systems and methods for user interface generation. Specifically, embodiments of the present invention are configured to provide a system and method for providing one or more user interfaces capable of displaying path and points of interest information data in an easily understandable and consumable manner. In a preferred embodiment, the system is configured to receive location information and generate location specific information into an easily readable and accessible user interface for display on a display element, such as a screen of a smartphone or tablet PC. In this preferred embodiment, the user interface is configured to display path and points of interest on a linear format without inclusion of nonessential information or standard geographic divergences (e.g., curves, bends, elevation change).

### BACKGROUND

With the proliferation of mobile computing devices, such as smartphones, tablet PCs and global positioning systems (GPS), individuals have been given the ability to locate themselves and navigate the world around them with the aid of such devices. In general, mobile computing devices utilize location based services to provide mapping systems that navigate users via a 2D or 3D representation of the world around them.

For instance, if a user wishes to walk in a city from a point A to a point B and use a mapping service application, such as GOOGLE MAPS on a smartphone, the software not only shows a route but also streets, buildings, landmarks and other places that are not located on the route (i.e., path between point A and point B). This is similar to a traditional map, where the representation shows more than just the route, but everything surrounding the route and contained on the map as well. For instance, if the scale of a map displayed on the mapping service application is 5 square miles, everything within that 5 square miles is shown, even where the route may only be a 1 mile walk between point A and point B on a single street (e.g., 100 ft wide).

The implication is that such mapping service applications simply provide too many non-relevant data points for users to consume. These non-relevant data points, and just the overwhelming amount of data provided (particularly in dense urban areas), can lead to unpleasant user experiences when a user simply wants to achieve a simple task. For example if a user simply wants to know what is on the current street a user is on, there is no way of receiving this specific data without also receiving information about what else is in the general radius or squared area of the user's vicinity.

Further, all current mapping service applications provide geographic specific detail, such as curves and corners on roads, and this requires the existing mapping service systems to draw traditional maps that need entire display screen of a mobile computing device.

Therefore, there is need in the art for a system and method for providing simplified path and points of interest user interfaces. These and other features and advantages of the present invention will be explained and will become obvious to one skilled in the art through the summary of the invention that follows.

### SUMMARY OF THE INVENTION

Accordingly, it is an aspect of the present invention to providing a system and method for providing simplified path and points of interest user interfaces. The following is a summary for providing a solution to the problem in the form of a system comprising one or more software and hardware elements for the purpose of providing simplified path and points of interest user interfaces. In certain embodiments, the system may be configured to connect with one or more third-party or otherwise remote systems for the provision of location information and location based data.

According to an embodiment of the present invention, a system for providing simplified path and points of interest user interfaces includes: a location based services module, comprising computer-executable code stored in non-volatile memory, a graphical user interface generation module, comprising computer-executable code stored in non-volatile memory, a processor, and a display element, wherein said location based services module, said graphical user interface generation module, said processor, and said display element are operably connected and are configured to: receive mapping user interface request; retrieve location information, wherein said location information is based at least in part on a location of a user as determined by said location based services module; retrieve location data, wherein said location data is based on said location information; generate a linear expression based on said location data, wherein said linear expression comprises information about locations along a specified route; generate a user interface based on said linear expression and said location data; and generate human perceptible output data usable by said display element.

According to an embodiment of the present invention, the location based services module, said graphical user interface generation module, said processor, and said display element are further configured to detect motion data such that said motion data is used to limit retrieval of location data to information along said specified route in a single direction.

According to an embodiment of the present invention, the single direction is determined by said motion data.

According to an embodiment of the present invention, the motion data is a change in direction, further requiring the retrieval of additional location data.

According to an embodiment of the present invention, the location based services module, said graphical user interface generation module, said processor, and said display element are further configured to: utilize said motion data to effect the scrolling of one or more of said linear expression and said user interface in a direction identified by said motion data; retrieve additional location data based on said direction; and update said user interface based on said additional location data.

According to an embodiment of the present invention, the user interface comprises a single linear path devoid of curvature.

According to an embodiment of the present invention, the location data comprises information related to businesses located along said specified route.

According to an embodiment of the present invention, the location data comprises information related to non-business points of interests located along said specified route.

According to an embodiment of the present invention, the location data comprises a cross-route identifier, wherein said cross-route identifier denotes an intersecting path with said specified route.

According to an embodiment of the present invention, a computer implemented method for providing simplified path and points of interest user interfaces, the method comprising the steps of: receiving a mapping user interface request based on user input; retrieving location information, wherein said location information is based at least in part on a location of a user as determined by a location based services module; retrieving location data via a communication means, wherein said location data is based on said location information; generating a linear expression based on said location data, wherein said linear expression comprises information about locations along a specified route; generating a user interface based on said linear expression and said location data; and generating human perceptible output data usable by a display element.

According to an embodiment of the present invention, the specified route may be one or more route types selected from the group comprising a street the user is currently on, a path between two points selected by the user, a path between the user's current location and a destination (such path may be determined, for instance, by the location based services module), a corridor or other pathway (e.g., hallway in a shopping center or mall, airport terminal, park path, hiking trail).

According to an embodiment of the present invention, the method further comprising the step of detecting motion data such that said motion data is used to limit retrieval of location data to information along said specified route in a single direction.

According to an embodiment of the present invention, the method further comprising the steps of: utilizing said motion data to effect the scrolling of one or more of said linear expression and said user interface in a direction identified by said motion data; retrieving additional location data based on said direction; and updating said user interface based on said additional location data.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a schematic overview of a network, in accordance with an embodiment of the present invention;

FIG. 3A illustrates a schematic of a system for providing a simplified path and points of interest user interfaces, in accordance with an embodiment of the present invention;

FIG. 3B illustrates a schematic of a system for providing a simplified path and points of interest user interfaces, in accordance with an embodiment of the present invention;

FIG. 3C illustrates a schematic of a system for providing a simplified path and points of interest user interfaces, in accordance with an embodiment of the present invention;

FIG. 4 is a process flow of an exemplary method in accordance with embodiments of the present invention;

FIG. 5 is a process flow of an exemplary method in accordance with embodiments of the present invention;

FIG. 6A is an exemplary illustration of a simplified user interface in accordance with embodiments of the present invention; and

FIG. 6B is an exemplary illustration of a simplified user interface in accordance with embodiments of the present invention.

### DETAILED SPECIFICATION

Embodiments of the present invention are generally directed towards systems and methods for user interface generation. Specifically, embodiments of the present invention are configured to provide a system and method for providing one or more user interfaces capable of displaying path and points of interest information data in an easily understandable and consumable manner. In a preferred embodiment, the system is configured to receive location information and generate location specific information into an easily readable and accessible user interface for display on a display element, such as a screen of a smartphone or tablet PC. Display elements may include, but are not limited to, e-ink screens, heads-up displays (e.g., presented on wearable display elements such as glasses), wearable displays (e.g., watches), smartphone displays, tablet PC displays, or any combination thereof. In the preferred embodiment, the user interface is configured to display path and points of interest on a linear format without inclusion of nonessential information or standard geographic divergences (e.g., curves, bends, elevation change).

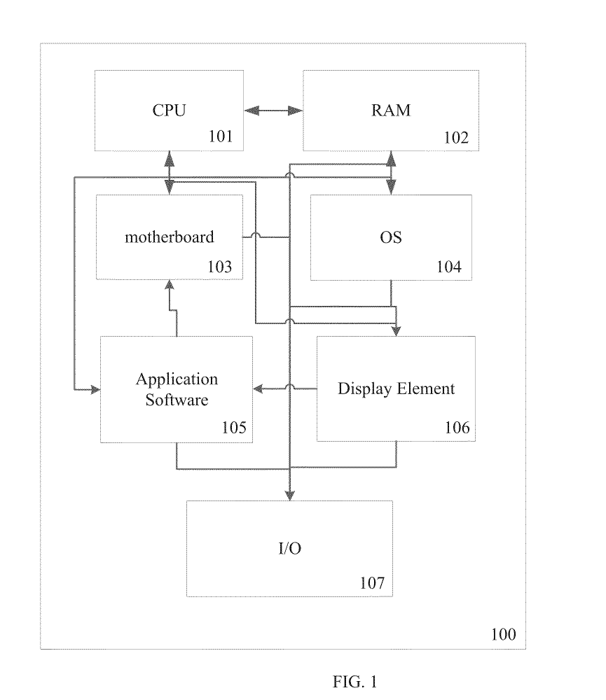

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, display element 106 and one or more input/output devices/means 107. Examples of computing devices usable with embodiments of the present invention include, but are not limited to, personal computers, smart phones, laptops, mobile computing devices and tablet PCs and servers. One of ordinary skill in the art would understand that any number of computing devices could be used, and embodiments of the present invention are contemplated for use with any computing device.

In a preferred embodiment of the present invention, the computing devices utilized will incorporate one or more input means and output means for use and interaction with the system. Input means may include, but are not limited to, touchscreen interfaces, keyboard interfaces, accelerometers, gyroscope, motion sensors, buttons, cameras, microphones and 3D imaging devices, or any combination thereof. Output means may include, but are not limited to, video displays elements, audio output devices (e.g., speakers, headphones), haptic output means (e.g., force feedback devices) or any combination thereof. One of ordinary skill in the art would appreciate that there are numerous input means and output means that could be utilized with embodiments of the present invention, and embodiments of the present invention are contemplated for use with any such input means and output means.

In an exemplary embodiment according to the present invention, data may be provided to the system, stored by the system and provided by the system to users of the system across local area networks (LANs) (e.g., office networks, home networks) or wide area networks (WANs) (e.g., the Internet, cellular data networks). In accordance with the previous embodiment, the system may receive data from one or more servers or other computing devices communicatively connected across one or more LANs and/or WANs. One of ordinary skill in the art would appreciate that there are numerous manners in which the system could connected and configured to receive and transmit (where applicable) data and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

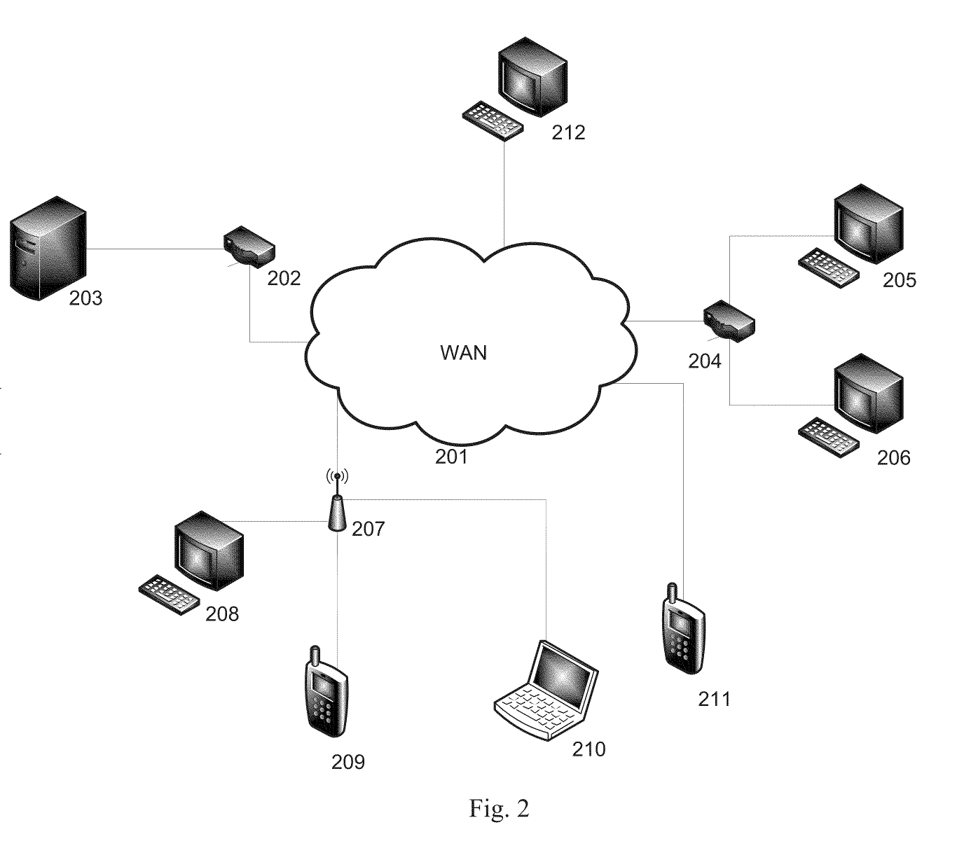

Referring to FIG. 2, a schematic overview of a system in accordance with an embodiment of the present invention is shown. Connection to such networks may be required or desirable for mobile computing device 211 to receive data from any number of sources required for generation of the user interface in accordance with embodiments of the present invention. According to an exemplary embodiment, as shown in FIG. 2, exchange of information through the Network 201 may occur through one or more high speed connections. In some cases, high speed connections may be over-the-air (OTA), passed through networked systems, directly connected to one or more Networks 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to Network 201 for the exchange of information with the mobile computing device 211 or with other computing devices for use with embodiments of the system, and embodiments of the present invention are contemplated for use with any method for connecting to networks for the purpose of exchanging information. Further, while this application refers to high speed connections, embodiments of the present invention may be utilized with connections of any speed.

Components of the system (e.g., mobile computing device 211) may connect to data server 203 via Network 201 or other network in numerous ways. For instance, a component may connect to the system: i) through a computing device 212 directly connected to the Network 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the Network 201. One of ordinary skill in the art would appreciate that there are numerous ways that a mobile computing device 211 may connect to server 203 via Network 201, and embodiments of the present invention are contemplated for use with any method for connecting to server 203 via Network 201. Furthermore, server 203 could be comprised of a personal computing device, such as a smartphone, acting as a host for other computing devices to connect to.

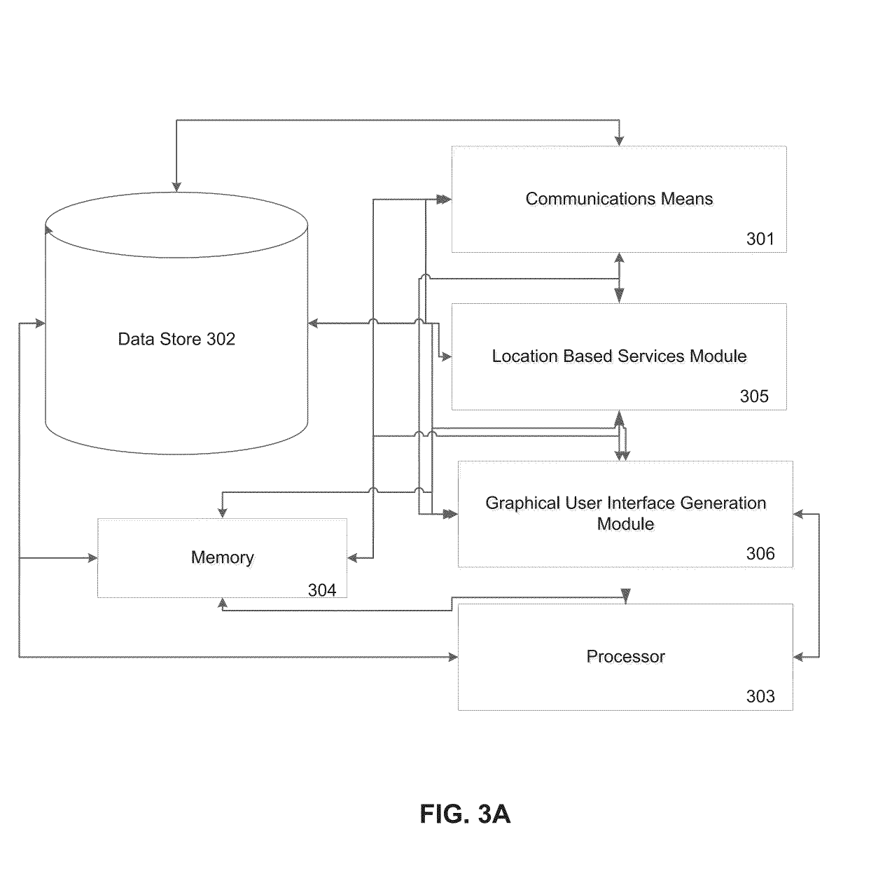

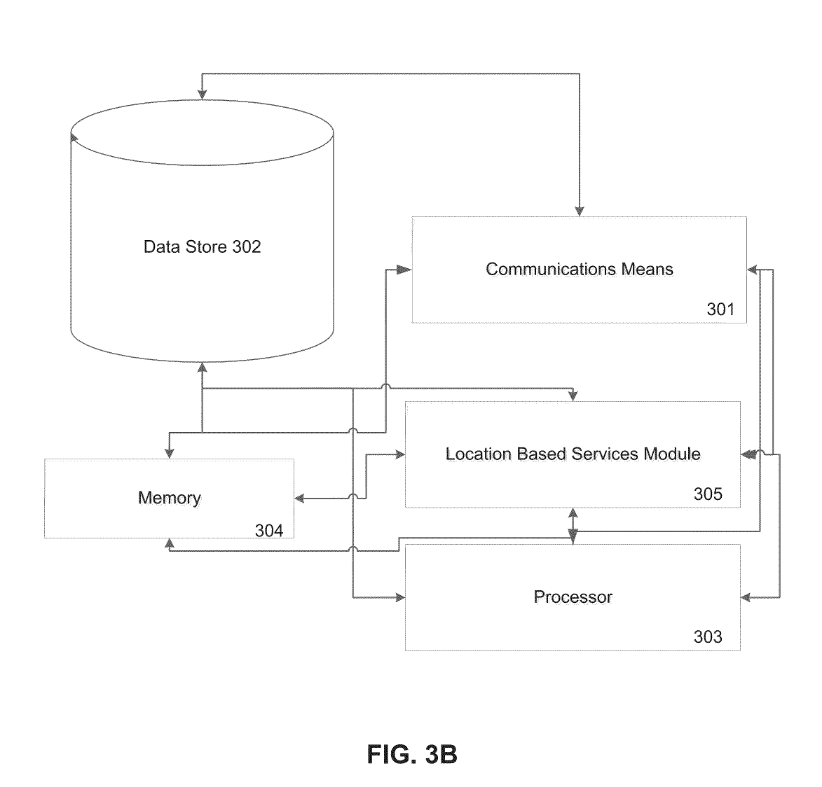

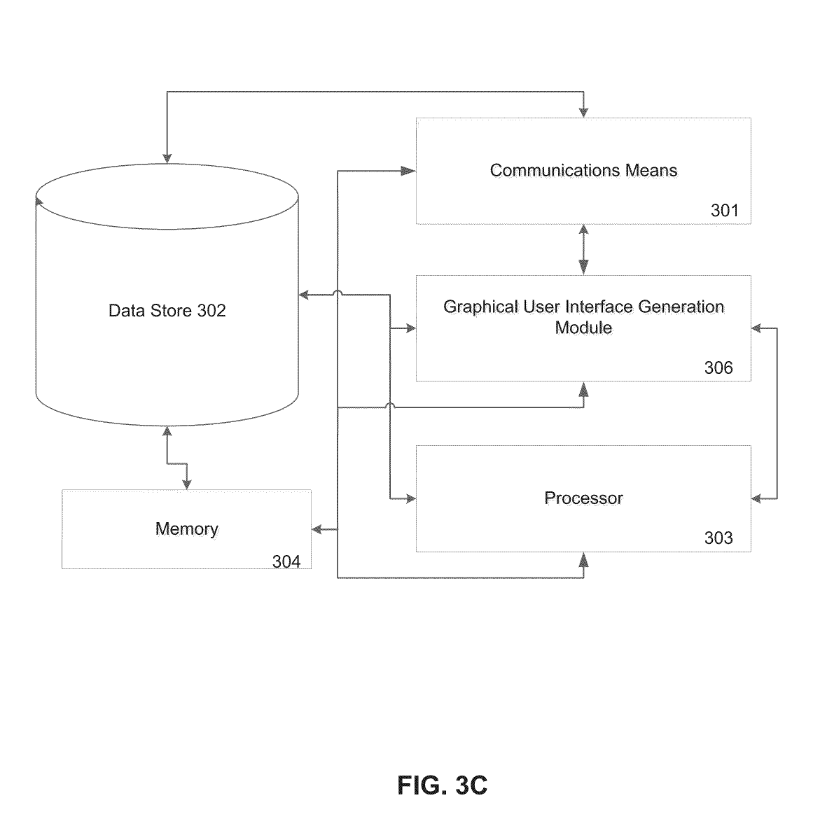

Turning to FIG. 3A, according to an embodiment of the present invention, a system for providing simplified path and points of interest user interfaces is comprised of one or more communications means 301, one or more data stores 302, a processor 303, memory 304, a location based services module 305 and a graphical user interface generation module 306. In FIG. 3B, according to an embodiment of the present invention, a system for providing simplified path and points of interest user interfaces is comprised of one or more communications means 301, one or more data stores 302, a processor 303, memory 304 and a location based services module 305. In FIG. 3C, according to an embodiment of the present invention, a system for providing simplified path and points of interest user interfaces is comprised of one or more communications means 301, one or more data stores 302, a processor 303, memory 304 and a graphical user interface generation module 306. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data, voice or video communications over one or more networks or to one or more peripheral devices attached to the system. Appropriate communications means may include, but are not limited to, wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

According to an embodiment of the present invention, the location based services (LBS) module is configured to work in conjunction with the processor, memory, data store and communications means to provide location information and location data to the system for the purpose of identifying the location of a user as well as determining or retrieving location data along an identified route. Location information may be determined by one or more location determination units, including, but not limited to, a GPS unit, a unit configured to provide location information based on triangulation of cellular or other signal information, or any combination thereof. One of ordinary skill in the art would appreciate that there are numerous types of location determination units that could be utilized with embodiments of the present invention, and embodiments of the present invention are contemplated for use with any such location determination unit type. In a preferred embodiment, location information is provided in a representation, such as mapping coordinates (e.g., latitude, longitude), but other embodiments may utilize any type of location information that can be converted into data points usable by the system to determine the location of a computing device the system is operating on.

According to an embodiment of the present invention, location data may include, but is not limited to, business information, contact information (e.g., personal contacts with addresses matching location information), cross-route information (e.g., cross-streets, alleyways, waterways), non-business information (e.g., parks, subways, museums, municipal centers, government buildings, mass transit locations, airports), or any combination thereof. One of ordinary skill in the art would appreciate that there are numerous types of location data that could be utilized with embodiments of the present invention, and embodiments of the present invention are contemplated for use with any type of location data.

According to an embodiment of the present invention, the LBS module may further be configured to determine motion data. Motion data includes, but is not limited to, direction, heading, speed, acceleration, or any combination thereof. The LBS module may be configured to utilize motion data in further aspects of the methods provided herein. For instance, the motion data can be utilized in order to limit location data retrieval to those location data points along the route in the direction the user is headed. Further embodiments may increase or decrease information retrieval rates based on the user's speed in order to limit bandwidth or processing power consumed by the system during operation.

According to an embodiment of the present invention, the LBS module may further be configured to determine orientation of a user of a mobile device. For instance, the LBS module may work in conjunction with components of the mobile computing device (e.g., gyroscopes, digital compasses) in order to determine a direction, facing or heading of a user without necessarily requiring motion in a particular direction. One of ordinary skill in the art would appreciate that there are numerous methods for determining orientation, and embodiments of the present invention are contemplated for use with any method for determining orientation.

According to an embodiment of the present invention, the graphical user interface (GUI) generation module is configured to work in conjunction with the processor, memory, data store and communications means to allow for the processing, generation and display of simplified path interfaces. In a preferred embodiment, the GUI generation module is configured to receive location information and location data from the LBS module and create a simple linear path GUI which eliminates all complex mapping elements and data and retains only a linear path and information about locations along that path. Used in conjunction with motion data from the LBS module, the GUI generation module may provide a continuous experience along the presented simple linear path GUI by scrolling along as the user moves about the path. In other embodiments, the simple linear path GUI may move forward or back in segments (e.g., every 100 ft, every 500 ft, every 1000 ft). In certain embodiments, the simple linear path GUI may further comprise an icon, marker or other graphical indicator to identify the location of the mobile device of the user on the GUI.

Certain embodiments of the present invention may allow the user to interact with the GUI in order to change the view portion of the GUI. For instance, the user may touch, click or otherwise interact with the display element or other human interface device connected to the mobile computing device in order to effect changes on the GUI. Changes to the GUI may include scrolling the GUI forward along a path, scrolling a GUI backward along a path, changing a zoom level of the GUI, changing the orientation of a GUI (e.g., vertical to horizontal), changing font size, changing color scheme, or any combination thereof. One of ordinary skill in the art would appreciate that there are numerous types of interactions and effects to the GUI that could be utilized with embodiments of the present invention, and embodiments of the present invention are contemplated for use with any such interaction type or GUI effect.

According to an embodiment of the present invention, the system is configured to provide mapping services to users with a simplified GUI. By removing the full 2D/3D map from the display and simplifying the GUI to just display a linear path and information data neatly segmented into individual elements along the linear path, users are provided a clean and easy to use and understand graphical representation of data points along a specified route.

For the purposes of the present invention, a specified route could be a street the user is currently on, a path between two points selected by the user, a path between the user's current location and a destination (such path may be determined, for instance, by the location based services module), a corridor or other pathway (e.g., hallway in a shopping center or mall, airport terminal, park path, hiking trail), or any combination thereof. One of ordinary skill in the art would appreciate that there are numerous types of specified routes that could be utilized with embodiments of the present invention, and embodiments of the present invention are contemplated for use with any type of specified route.

According to an embodiment of the present invention, the system is configured to receive mapping information from a mapping service application or mapping service provider, such as by way of an Application Programming Interface (API) provided over a communications network. The system then processes the mapping data to remove all mapping features (e.g., side streets, landmarks, buildings, curvatures of roads) and generate a linear path based on the location of the mobile device of the user. The linear path represents a simplified view of the location of the user, such as the street the user is on. If the street has a curve in it, the simplified view will not show the curve. As the user walks along the curve in the road, the user's location on the linear path shown on the simplified view is simply represented by moving a visual indicia forward or backward on the linear path. In other embodiments, mapping data may be stored locally on the mobile computing device used by the user and retrieved as required. In still further embodiments, the mapping data may be provided by a connection to a remote system through means other than an API. One of ordinary skill in the art would appreciate that there are numerous methods and systems capable of providing mapping data to the system for use in the GUI generation process, and embodiments of the present invention are contemplated for use with any system or method for providing/receiving mapping data.

In one embodiment, the system is configured to determine the location of a user by way of a location based services module and retrieve the location data for points on a road, street or other path the user is currently on and reduce the location data to the simplified GUI in accordance with the methods described herein. In a preferred embodiment, the simplified GUI may be comprised of (i) a line representing a specified route, (ii) a plurality of information data indicia representing the location of various points along the specified route, and (iii) a plurality of information description elements containing brief informative descriptions of the points along the specified route. In the preferred embodiment, the simplified GUI may further be configured to highlight the location of the user by one or more of (i) a representative icon showing the user on the line representing the specified route; (ii) highlighting or otherwise making visually distinguishable one of the plurality of information data indicia; (iii) highlighting or otherwise making visually distinguishable one of the plurality of information description elements; or (iv) any combination thereof. Where the indicia or elements are made visually distinguishable or highlighted, the selected indicia or element will be the element or indicia representing the location nearest to the location of the user.

In certain embodiments, the system may be configured to use information data indicia and/or information description elements to represent cross-streets or other potential intersecting paths along the specified route. The user may interact with these information description elements to see what is on the alternative routes. For instance, if the user is looking for a coffee shop and does not see one located on a specified route (e.g., a street), the user can interact with an information description element representing an alternative route. The system can be configured to generate a new linear path for the alternative route and show the display to the user what is on the alternative route. In an alternative embodiment, the system can be configured to retrieve information data for the alternative route and simply list out information data (e.g., business names, business types) on the alternative route.

In certain embodiments, the system may be configured to detect the motion of the user such that if the user leaves a specified route and moves onto an alternative route, the system can automatically generate a new specified route and simplified GUI for the new specified route. In this manner, the user is able to see, in real-time, information data related to the path the user is currently on.

In certain embodiments, the system may allow the user to provide information related to a type of location a user is interested in finding. For instance, a user may be interested in finding nearby restaurants, museums, entertainment facilities, bathrooms, post offices, or any other location type. The system may be configured to identify locations meeting the user's specified desires by highlighting or otherwise making such locations visually distinguishable on the simplified GUI. For instance, the system may highlight each information description element meeting the user's desire, highlighting each information data indicia meeting the user's desire, or any combination thereof. In certain embodiments, the system may also provide additional information, such as distance or time to a matching location based on current pace/velocity.

### Exemplary Embodiments

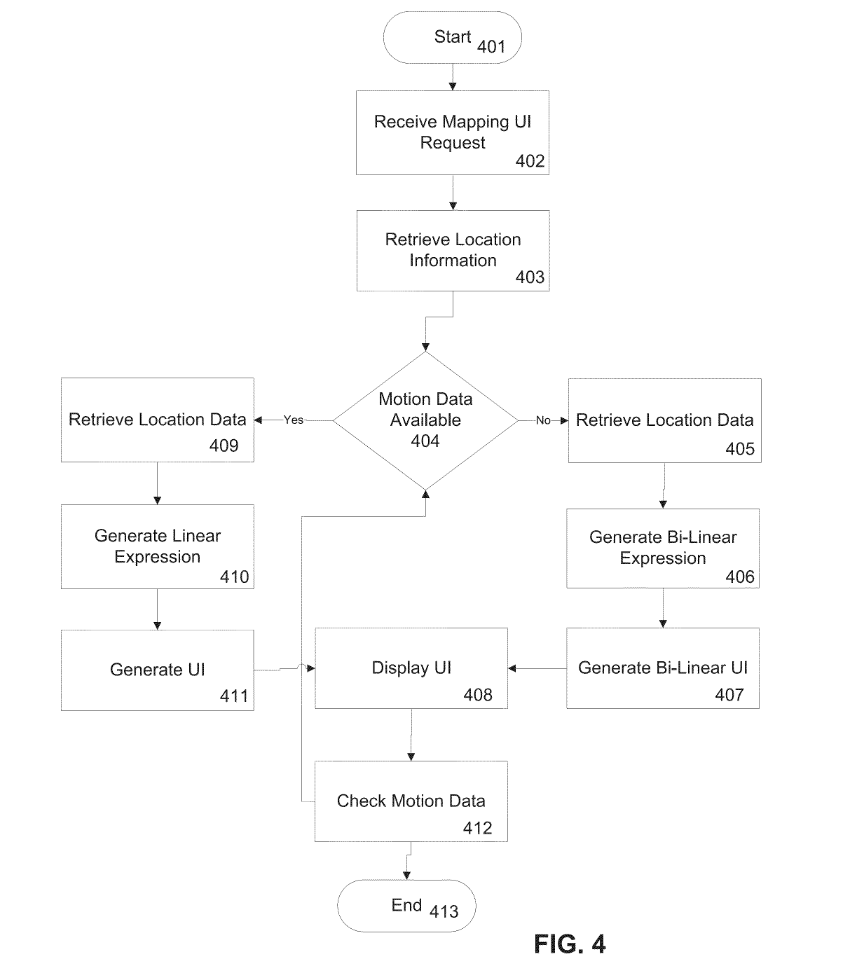

Turning now to FIG. 4, an exemplary method for providing a simplified path and points of interest user interface is shown. The process starts at Step 401 with a user interacting with the system in order to receive a simple linear path GUI. At step 402, the system receives the request and extracts the information received from the request. Information associated with a request may include, but is not limited to, specified route, user destination, user desire, user identification, communications availability (e.g., GPS signal, cellular signal), or any combination thereof.

At step 403, the system retrieves location information. Generally this is accomplished by way of the location based services module retrieving location information from a GPS unit or other location unit. At step 404, the system determines if motion data is available.

If motion data is not currently available, the system may retrieve location data for locations along a specified route (step 405) and generate a bi-linear expression for use in the simple linear path GUI. A bi-linear expression is provided to allow for determination of location data along both directions of a specified route (e.g., forward and backward). Since direction and/or heading is not available, the bi-linear expression is utilized to provide the user with information data for locations in both directions on a specified route.

At step 407, the system generates the bi-linear simplified GUI. Generation of the bi-linear simplified GUI may include retrieving information data from one or more networks as detailed herein. Once the simplified GUI is generated, the system transmits the simplified GUI to the display element (step 408). At this point, the system can continue to loop through the process by checking again for motion data (step 404) or the system can terminate the process (generally upon receipt of a termination command from the user) (step 413).

Where motion data is available at step 404, the system can retrieve location data at step 409 with information being retrieved in a manner that may favor the direction of movement of the user. Since the user is headed in a direction, the linear expression may be generated such that the graphical elements and information data favor the current direction (step 410). For example, the linear expression with motion data available may present a greater portion of the linear expression is directed to the specified route ahead of the user, and a lesser portion of the linear expression is directed to the specified route behind the user.

At step 411, the system generates the simplified GUI and sends the simplified GUI to the display element (step 408). At this point, the system can continue to loop through the process by checking again for motion data (step 404) or the system can terminate the process (generally upon receipt of a termination command from the user) (step 413).

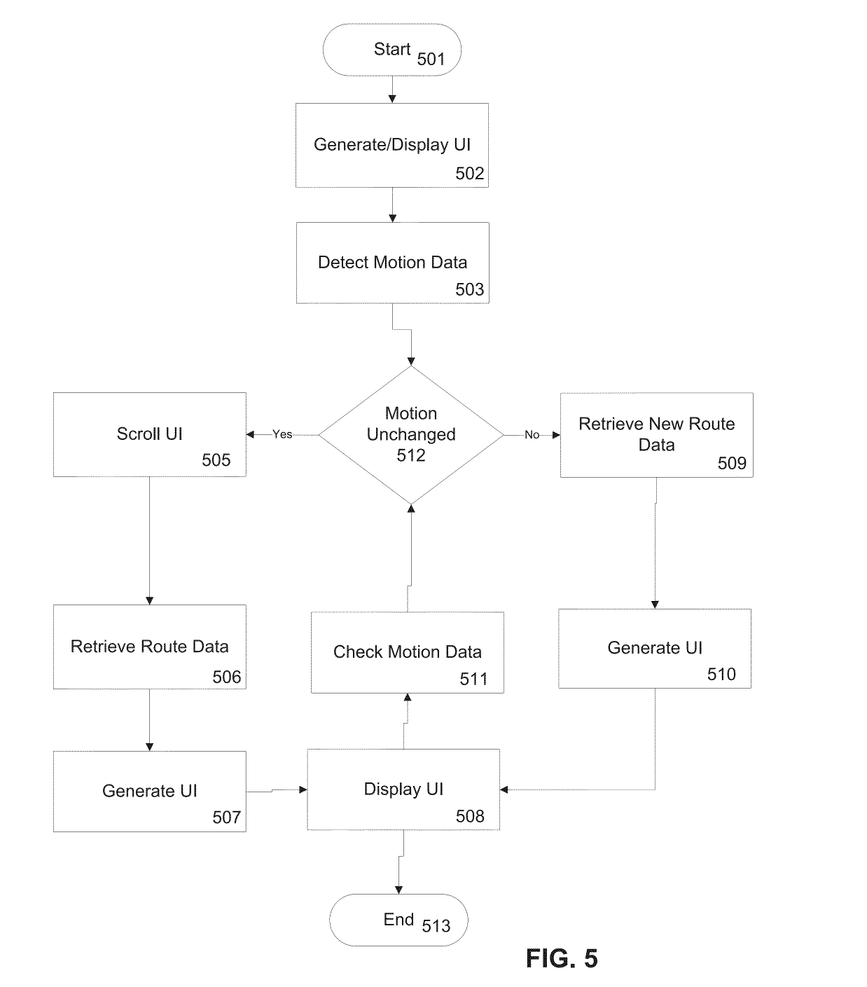

Turning now to FIG. 5, an exemplary method for providing a simplified path and points of interest user interface is shown. The process starts at Step 501 with a user interacting with the system currently providing a simple linear path GUI. At step 502, the system generates and displays a simplified linear path GUI to the user based on data available to the system.

At step 503, the system detects motion data provided by components of the system. If motion data is the same as the motion data previously detected by the components of the system (i.e., user is heading in the same direction at the same speed), the system scrolls the simplified linear path based on the motion data (e.g., distance travelled, velocity) (step 505). Concurrently, before or after or in conjunction with, the system also retrieves route data (i.e., information data) for points along the specified route (step 506).

At step 507, the system generates and updates simple linear path GUI and provides the simple linear path GUI to the display element (step 508). The process then can continue to check for motion data (step 511) and loop through the process or otherwise terminate (generally upon request from the user) (step 513).

If motion data has changed, the system is configured to retrieve new route data at step 509. New route data is based on the change in motion data. This may involve a change in specified route or a change in a direction of travel on a current specified route. Either way, the system retrieves the appropriate information data for the simple linear path GUI and generates the GUI accordingly (step 510). At this point, the system provides the simple linear path GUI to the display element (step 508). The process then can continue to check for motion data (step 511) and loop through the process or otherwise terminate (generally upon request from the user) (step 513).

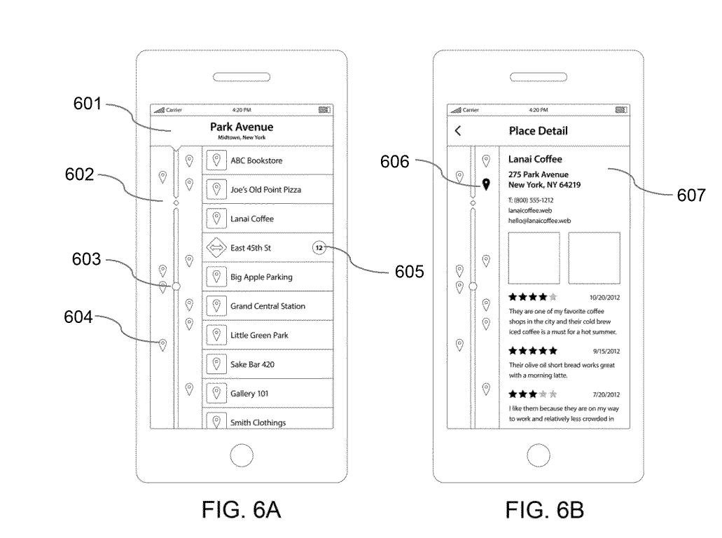

Turning now to FIGS. 6A and 6B, exemplary embodiments of a GUI generated by the system are shown. In these figures, various data points are shown as generated by the system related to the route. For instance, these exemplary GUI embodiments show the route name or road name of the current route 601, a cross-route marker 602, the linear path with user location icon 603, points of interest markers 604, cross-street information data (including, in this example, number of data points on the cross-street) 605, highlighted points of interest marker 606 and information description elements 607. As shown the information description elements may include, but are not limited to, name of the element (e.g., business name, contact name, non-business information name), address, contact information, images (e.g., retrieved from a source such as a search engine), reviews, other relative information, or any combination thereof.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing simplified path and points of interest user interfaces, the system comprising:
a location based services module, comprising computer-executable code stored in non-volatile memory,
a graphical user interface generation module, comprising computer-executable code stored in non-volatile memory
a processor, and
a display element,
wherein said location based services module, said graphical user interface generation module, said processor, and said display element are operably connected and are configured to:
receive mapping user interface request;
retrieve location information, wherein said location information is based at least in part on a location of a user as determined by said location based services module;
retrieve location data, wherein said location data is based on said location information;
generate a linear expression based on said location data, wherein said linear expression comprises information about locations along a specified route;
generate a user interface based on said linear expression and said location data; and
generate human perceptible output data usable by said display element.

2. The system of claim 1, wherein said location based services module, said graphical user interface generation module, said processor, and said display element are further configured to detect motion data such that said motion data is used to limit retrieval of location data to information along said specified route in a single direction.

3. The system of claim 2, wherein said single direction is determined by said motion data.

4. The system of claim 2, wherein said motion data is a change in direction, further requiring the retrieval of additional location data.

5. The system of claim 2, wherein said location based services module, said graphical user interface generation module, said processor, and said display element are further configured to:
utilize said motion data to effect the scrolling of one or more of said linear expression and said user interface in a direction identified by said motion data;
retrieve additional location data based on said direction; and
update said user interface based on said additional location data.

6. The system of claim 1, wherein said user interface comprises a single linear path devoid of curvature.

7. The system of claim 1, wherein said location data comprises information related to businesses located along said specified route.

8. The system of claim 1, wherein said location data comprises information related to contacts located along said specified route.

9. The system of claim 1, wherein said location data comprises a cross-route identifier, wherein said cross-route identifier denotes an intersecting path with said specified route.

10. A computer implemented method for providing simplified path and points of interest user interfaces, the method comprising the steps of:
receiving a mapping user interface request based on user input;
retrieving location information, wherein said location information is based at least in part on a location of a user as determined by a location based services module;
retrieving location data via a communication means, wherein said location data is based on said location information;
generating a linear expression based on said location data, wherein said linear expression comprises information about locations along a specified route;
generating a user interface based on said linear expression and said location data; and
generating human perceptible output data usable by a display element.

11. The method of claim 10, further comprising the step of detecting motion data such that said motion data is used to limit retrieval of location data to information along said specified route in a single direction.

12. The method of claim 11, wherein said single direction is determined by said motion data.

13. The method of claim 11, wherein said motion data is a change in direction, further requiring the retrieval of additional location data.

14. The method of claim 11, further comprising the steps of:
utilizing said motion data to effect the scrolling of one or more of said linear expression and said user interface in a direction identified by said motion data;
retrieving additional location data based on said direction; and
updating said user interface based on said additional location data.

15. The method of claim 10, wherein said user interface comprises a single linear path devoid of curvature.

16. The method of claim 10, wherein said location data comprises information related to businesses located along said specified route.

17. The method of claim 10, wherein said location data comprises information related to contacts located along said specified route.

18. The method of claim 10, wherein said location data comprises a cross-route identifier, wherein said cross-route identifier denotes an intersecting path with said specified route.
